(19) United States
(12) Patent Application Publication
(10) Pub. No.: US 2019/0353228 A1
(43) Pub. Date: Nov. 21, 2019

(54) ANTI-RETURN SYSTEM FOR HYDRAULIC TENSIONER

(71) Applicant: BorgWarner Inc., Auburn Hills, MI (US)

(72) Inventor: Young Taek SUN, Gyeonggi-do (KR)

(21) Appl. No.: 16/476,950

(22) PCT Filed: Jan. 11, 2017
(86) PCT No.: PCT/US2017/012989

§ 371 Date: Jul. 10, 2019

(51) Int. Cl. F16H 7/08

(52) U.S. Cl. CPC F16H 7/0834; F16H 7/0848; F16H 2007/0806; F16H 2007/0878; F16H 2007/0851; F16H 2007/0855; F16H 2007/0859; F16H 2007/0812

(57) ABSTRACT

A hydraulic tensioner includes piston retaining, anti-return, and anti-rotation functions. A ratchet clip for the tensioner preferably has straight sides or legs substantially perpendicular to a connecting portion. The ratchet clip preferably is substantially rectangular or U-shaped. The ends of the ratchet clip opposite the connecting portion are preferably bent inwards after the ratchet clip has been assembled on the tensioner. The ratchet clip performs the piston retaining function, the anti-rotation function and the anti-return functions. It is unnecessary for the user to remove the ratchet clip after the tensioner is assembled on the engine.

### BACKGROUND OF THE INVENTION

### Field of the Invention

The invention pertains to the field of hydraulic tensioners. More particularly, the invention pertains to an anti-return system for a hydraulic tensioner.

### Description of Related Art

Hydraulic tensioners use engine oil pressure with spring force for chain motion and tension control for engine timing systems. An anti-return function in hydraulic tensioners prevents chain tooth jump. Hydraulic tensioners also need to be able to retain the piston before the hydraulic tensioner is assembled on the engine. Prior art tensioners require a retaining pin that must be removed after the tensioner is assembled on the engine. Some existing hydraulic tensioners have a ratchet clip for an anti-return function and a retaining pin for retaining the piston in the tensioner body. But, the ratchet clip has a complicated design and the retaining pin must be removed after the hydraulic tensioner is assembled on the engine. Prior art tensioners also do not have a mechanism to prevent rotation of the piston.

A prior art hydraulic tensioner 1 is shown in FIGS. 1A and 1B. The hydraulic tensioner 1 includes a tensioner body 10, a retaining pin 15, a retaining hook 8, a ratchet clip 18, a piston 12, a vent disk 13 (to reduce volume of the tensioner), a hydraulic pressure chamber 14, a check valve assembly 20, and a spring 16. The piston 12 includes teeth 21 that interact with the ratchet clip 18 for piston control. The tensioner body 10 defines a cylindrical bore 11 for slidably receiving the hollow piston 12. One end of the bore 11 contains an inlet 17 in fluid communication with an external supply of pressurized fluid (not shown). The hydraulic pressure chamber 14 is defined by an inner circumference of the hollow piston 12, bore 11, compression spring 16 and the check valve assembly 20. The compression spring 16 biases the piston 12 away from the inlet 17. The check valve assembly 20 is located at the base of the piston bore 11 to allow hydraulic fluid to fill the space in the piston bore 11. Check valve assemblies 20 typically include a retainer, a spring, a ball, a seat and a seal.

### SUMMARY OF THE INVENTION

A hydraulic tensioner includes piston retaining, anti-return, and anti-rotation functions. A ratchet clip for the tensioner has a simple design to simplify tensioner assembly. The ratchet clip performs the piston retaining function, the anti-rotation function and the anti-return functions. It is unnecessary for the user to remove the ratchet clip after the tensioner is assembled on the engine. The ratchet clip permits control of tensioner backlash in the new and worn chain conditions by changing the backlash. The tensioner preferably has several backlashes which are suitable for different conditions.

In one embodiment, a hydraulic tensioner includes a tensioner body having a bore in fluid communication with a source of pressurized fluid through an inlet and a hollow piston slidably received within the bore, with an outer diameter comprising a plurality of teeth. An extension end of the piston has at least one first flat top surface. The hydraulic tensioner also includes a hydraulic pressure chamber defined by the hollow piston and the bore of the tensioner body, a piston spring received within the hydraulic pressure chamber for biasing the piston away from the inlet, and a substantially U-shaped ratchet clip inserted in a first hole and a second hole in the tensioner body such that the ratchet clip at least partially surrounds an outer diameter of the piston.

In another embodiment, a method controls piston movement in a tensioner including a tensioner body having a bore in fluid communication with a source of pressurized fluid through an inlet, a hollow piston slidably received within the bore, with an outer diameter including a plurality of ratchet teeth and an extension end of the piston having at least one first flat top surface, a hydraulic pressure chamber defined by the hollow piston and the bore of the tensioner body, a piston spring received within the hydraulic pressure chamber for biasing the piston away from the inlet, and a ratchet clip including two legs parallel to each other, a connecting section perpendicular to the legs that connects the two legs, and a bendable section at an end of each leg opposite the connecting section. The method includes the step of preventing retraction of the piston more than a set backlash amount. The ratchet clip acts as a non-return mechanism coupled to the piston, where the non-return mechanism includes the plurality of ratchet teeth formed along a length of the piston contacting the legs of the ratchet clip, such that the piston extends, but does not retract more than the set backlash amount.

In another embodiment, a ratchet clip for a tensioner including a tensioner body having a bore in fluid communication with a source of pressurized fluid through an inlet, a hollow piston slidably received within the bore, with an outer diameter comprising a plurality of teeth and an extension end of the piston having at least one first flat top surface, a hydraulic pressure chamber defined by the hollow piston and the bore of the tensioner body, and a piston spring received within the hydraulic pressure chamber for biasing the piston away from the inlet, includes two legs parallel to each other, a connecting section perpendicular to the legs that connects the two legs, and a bendable section at an end of each leg opposite the connecting section.

### BRIEF DESCRIPTION OF THE DRAWINGS

FIG. 1A shows a prior art tensioner.

FIG. 1B shows a cross-sectional view of the tensioner of FIG. 1A.

FIG. 2A shows a tensioner in an embodiment of the invention.

FIG. 2B shows a cross-sectional view of the tensioner of FIG. 2A.

FIG. 3A shows a ratchet clip before assembly of the tensioner in an embodiment of the present invention.

FIG. 3B shows the ratchet clip after assembly of the tensioner in an embodiment of the present invention.

FIG. 4A shows a view of a piston in an embodiment of the present invention.

FIG. 4B shows another view of the piston of FIG. 4A.

FIG. 5A shows a shipping condition of a tensioner in an embodiment of the present invention.

FIG. 5B shows the tensioner of FIG. 5A, with some of the interior components visible.

FIG. 5C shows the tensioner after the ratchet clip has moved out of the way of the piston and the piston has moved forward.

FIG. 5D shows the tensioner of FIG. 5C, with some of the interior components visible.

FIG. 6 shows a close up view of the ratchet clip on the tensioner, and the anti-return function.

FIG. 7A shows another view of the ratchet clip, and the interaction to prevent rotation of the piston.

FIG. 7B shows the ratchet clip and tensioner body of FIG. 7A, with some of the interior components visible.

FIG. 8A shows a piston with a tooth geometry for large backlash.

FIG. 8B shows a piston with a tooth geometry for small backlash.

FIG. 8C shows a piston with a tooth geometry for double backlash.

FIG. 9A shows the geometry of a tensioner body in an embodiment of the present invention.

FIG. 9B shows a sectional view of the front of a tensioner body.

### DETAILED DESCRIPTION OF THE INVENTION

A hydraulic tensioner includes a ratchet clip, piston and tensioner body. The tensioner does not include a retaining pin. Instead, the ratchet clip also performs the functions of a retaining pin, but does not need to be removed after assembling the tensioner on the engine.

A tensioner includes a piston retaining function. The piston is retained before the tensioner is assembled on the engine. Conventional tensioners include a retaining pin and hooks to retain the piston, and the user needs to remove the retaining pin after the tensioner is assembled on the engine. In contrast, in the tensioners described herein, the piston has at least one flat surface on the tip of the piston and the tensioner body has two holes for location of a ratchet clip. The ratchet clip has a piston retaining function and a separate retaining pin is unnecessary. When the tensioner is assembled on the engine, the ratchet clip is moved upwards (away from the engine block surface) out of the path of piston extension so that the ratchet clip no longer limits the extension of the piston during use.

The tensioner also preferably includes an anti-return function. The piston has teeth on its outer surface and the legs of the ratchet clip, located in the two holes on the tensioner body, contact the teeth of the piston. The ratchet clip acts as a non-return mechanism coupled to the piston, such that the piston extends but does not retract more than an included backlash amount.

The tensioner also preferably includes an anti-rotation function. While some users want to prevent the piston from rotating during use, conventional tensioners do not have this capability. In the tensioners described herein, the piston preferably has two flat top surfaces at different heights and the ratchet clip has a rectangular or U-shape to prevent piston rotation.

The ratchet clip preferably has straight sides or legs substantially perpendicular to a connecting portion. The ratchet clip preferably is substantially rectangular or U-shaped. The ends of the ratchet clip opposite the connecting portion are preferably bent inwards after the ratchet clip has been assembled on the tensioner.

The tensioner body preferably includes two holes sized to fit the sides of the ratchet clip. The extension tip of the piston preferably includes at least one flat surface, or step, across which the connecting portion of the ratchet clip extends. In some preferred embodiments, the piston includes a first flat top surface on its outer diameter, and a second flat top surface interior to the first flat top surface which is taller than the first flat top surface.

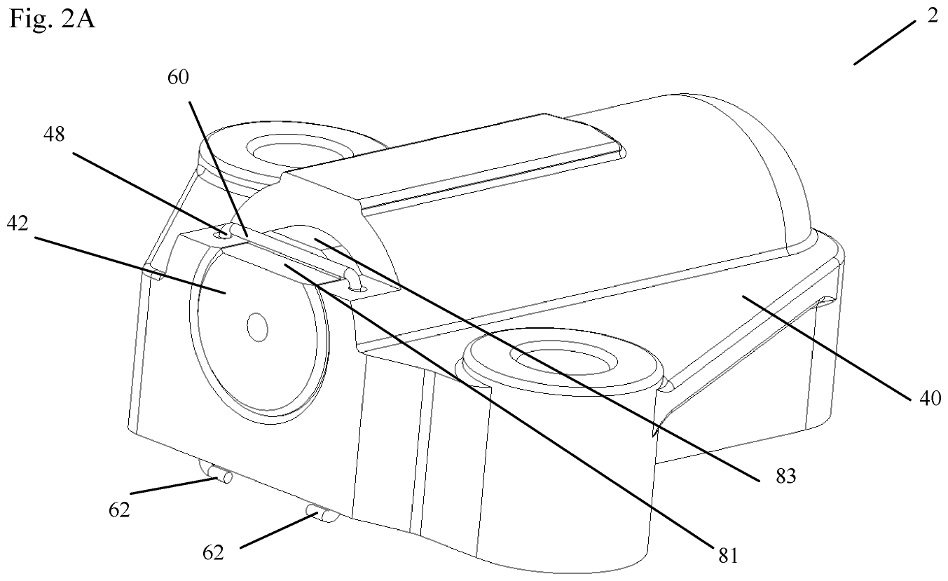

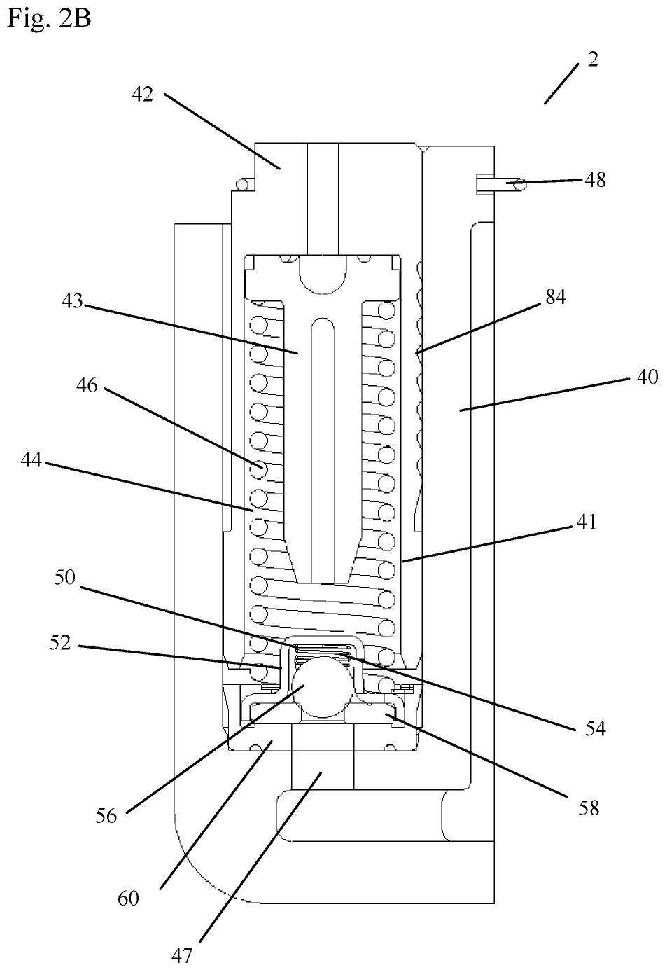

FIGS. 2A through 9B show a tensioner 2 in an embodiment of the present invention. The tensioner 2 includes a tensioner body 40, a ratchet clip 48, a piston 42, a vent disk 43 (to reduce volume of the tensioner), a hydraulic pressure chamber 44, a conventional check valve assembly 50, and a spring 46. The tensioner body 40 defines a cylindrical bore 41 for slidably receiving the hollow piston 42. One end of the bore 41 contains an inlet 47 in fluid communication with an external supply of pressurized fluid (not shown). The hydraulic pressure chamber 44 is defined by an inner circumference of the hollow piston 42, bore 41, compression spring 46 and the check valve assembly 50. The compression spring 46 biases the piston 42 away from the inlet 47.

The check valve assembly 50 is located at the base of the piston bore 41 to allow hydraulic fluid to fill the space in the piston bore 51. Although any check valve assembly known in the art could be used, the check valve assembly 50 in the figures includes a retainer 52, a spring 54, a ball 56, a seat 58, and a seal 60. The tensioner 2 does not include a retaining pin, as required by the prior art.

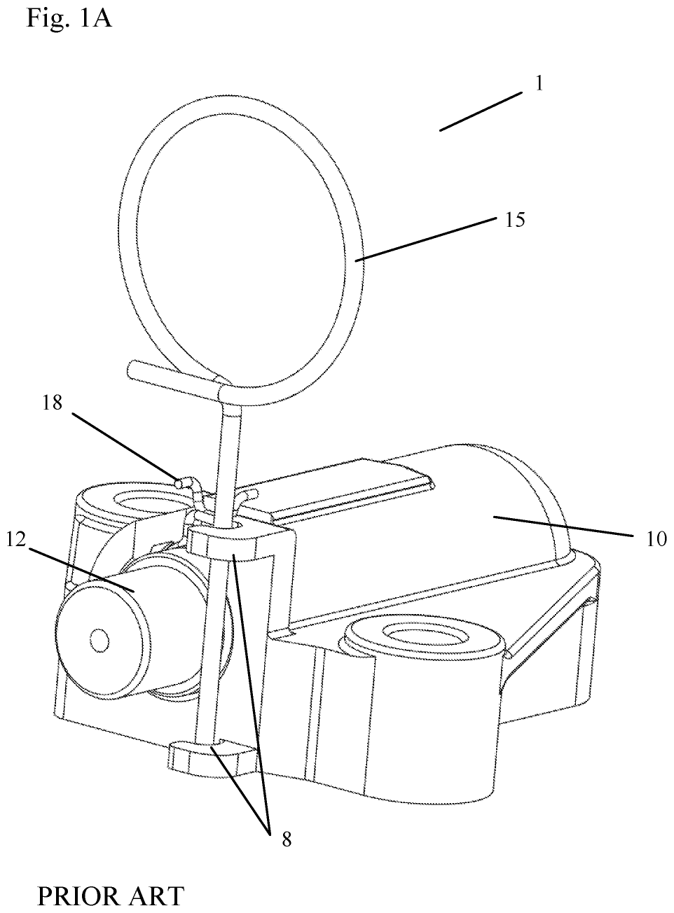

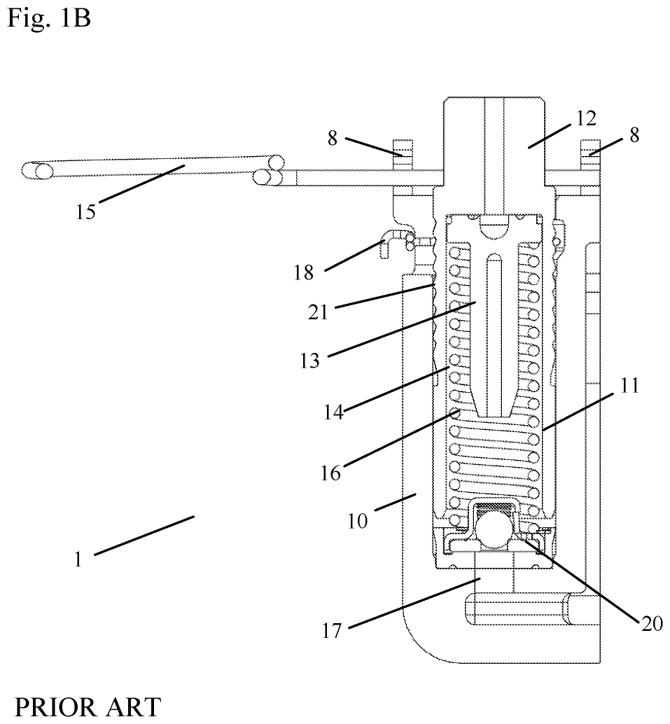

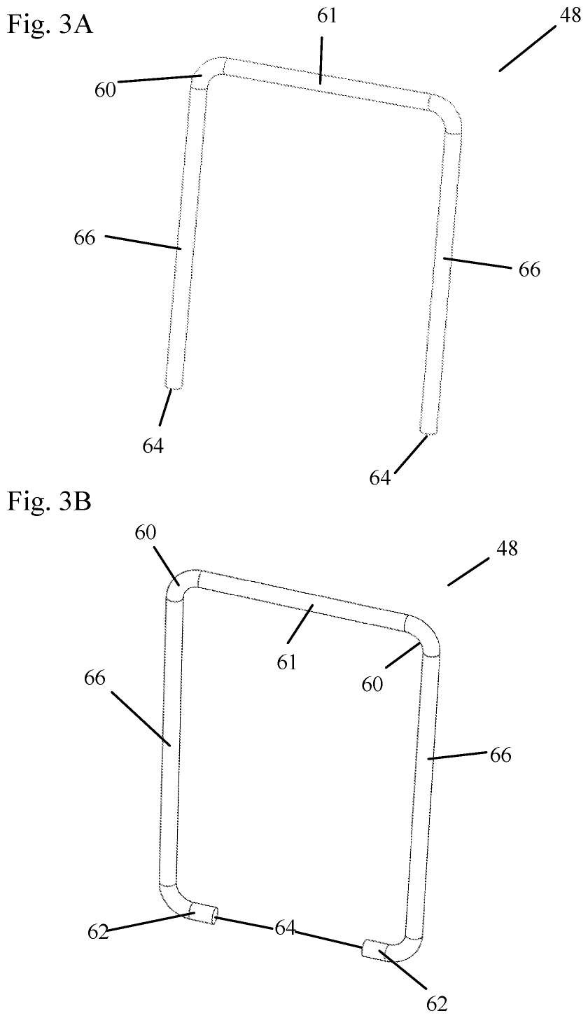

As shown in FIGS. 3A and 3B, the ratchet clip 48 is substantially rectangular or U-shaped with straight sides and substantially right angles forming the corners 60, which are preferably curved. The ratchet clip 48 is preferably made of steel wire and includes a connecting portion 61 and legs 66. The corner radius is preferably the same as the diameter of the wire used for the ratchet clip 48. There are two bendable portions 62 at the ends 64 of the legs 66. Pre-assembly, as shown in FIG. 3A, the legs 66 are parallel to each other and are not bent. After assembly onto a tensioner, as shown in FIG. 3B, the ends 64 of the legs 66 are bent inwards towards each other. The ends 64 of the ratchet clip 48 are bent after assembling on the tensioner body 40. The shape of the ratchet clip 48 is very different from the shape of the ratchet clip 18 shown in the prior art (see FIGS. 1A and 1B).

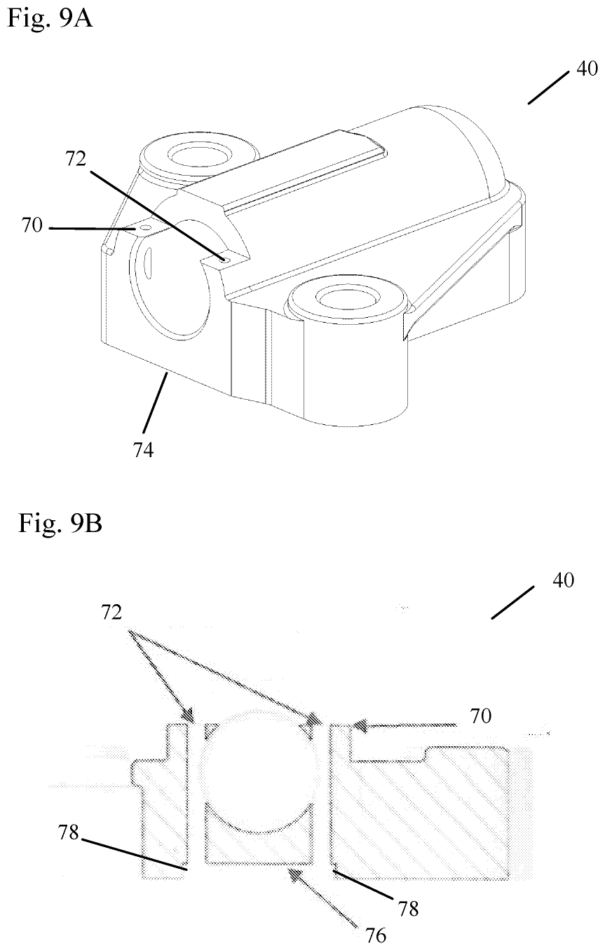

As shown in FIGS. 9A and 9B, the tensioner body 40 includes a flat surface 70 and two holes 72 for ratchet clip insertion and assembly. The bottom 74 of the tensioner body also includes a flat surface 76 for the bendable portions 62 of the legs 66 to contact. There is also a slot 78 at the bottom 74 of the tensioner body which permits positioning and bending of the ratchet clip 48 onto the tensioner body 40. The holes 72 cross the tensioner body bore so the ratchet clip 48 can contact the piston teeth 84 through the holes 72. Unlike prior art tensioners, the tensioner body 40 preferably does not have an opening or ratchet window for the ratchet clip, which eliminates the oil flow leakage from those openings.

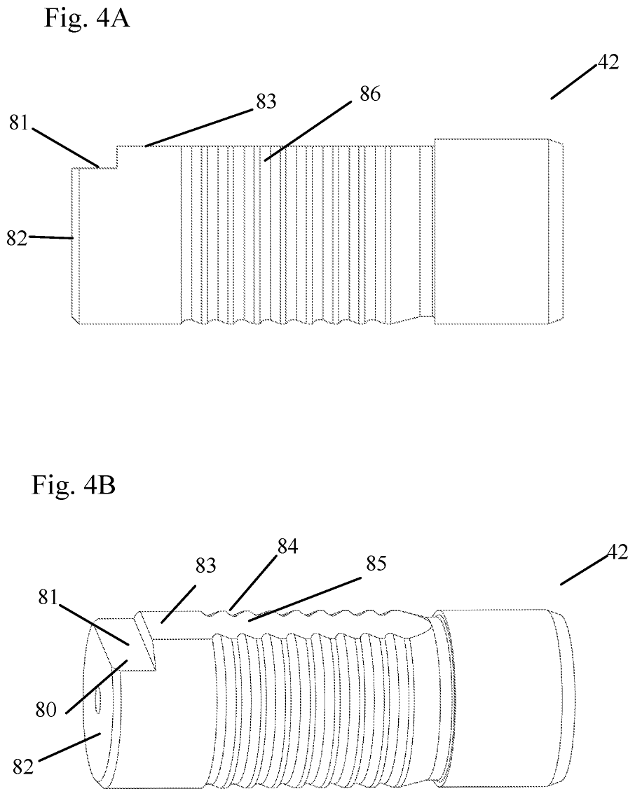

FIGS. 4A and 4B show details of the piston 42. The piston 42 in FIGS. 4A and 4B includes two steps 81, 83. The steps 81, 83 are formed by flat surfaces 80, 85, respectively on a top of the outer diameter 86 of the piston.

There are teeth 84 on the piston outer surface 86. The teeth 84 contact the ratchet clip 48 to prevent rotation. The piston 42 has at least one flat surface 80 on a top of its tip/end 82 to retain the piston. The flat surface 80 forms the first step 81. A second step 83, with a second flat surface, 85, is also preferably present on the piston 42. In embodiments with anti-rotation, the piston 42 includes both the first step 81 and the second step 83 on the piston 42 outer diameter 86. Due to the second step 83, the ratchet clip 48 can travel forward, but can only travel backwards a certain amount, until it hits the second step 83.

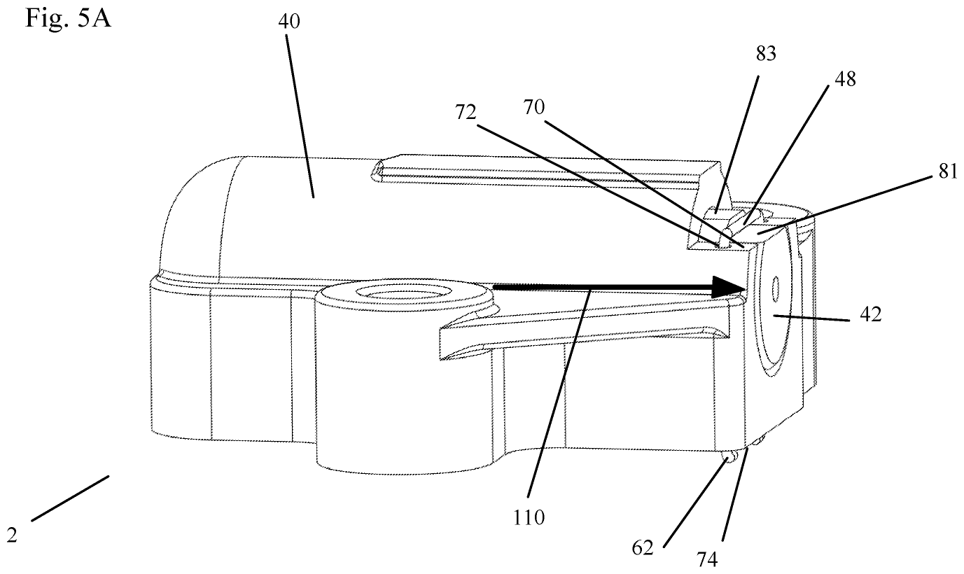

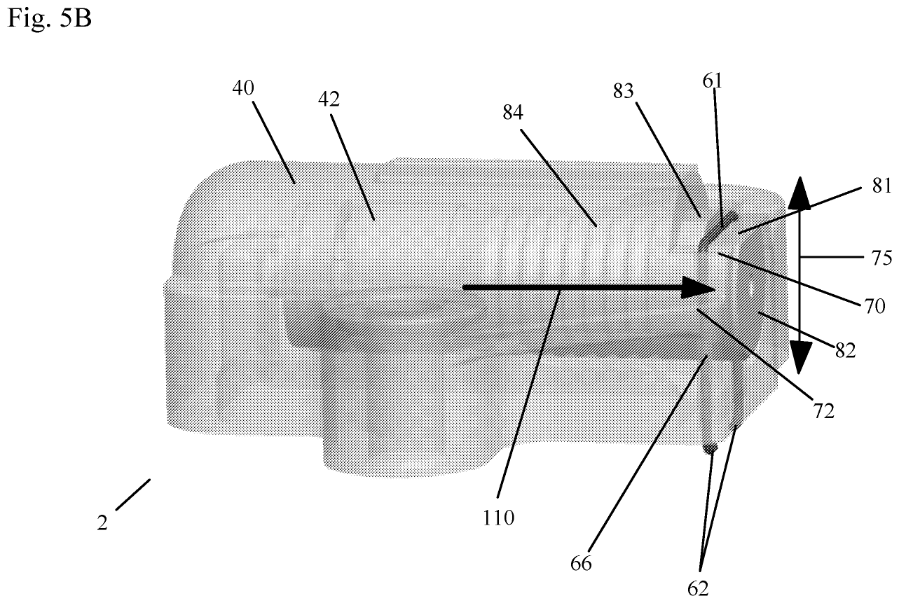

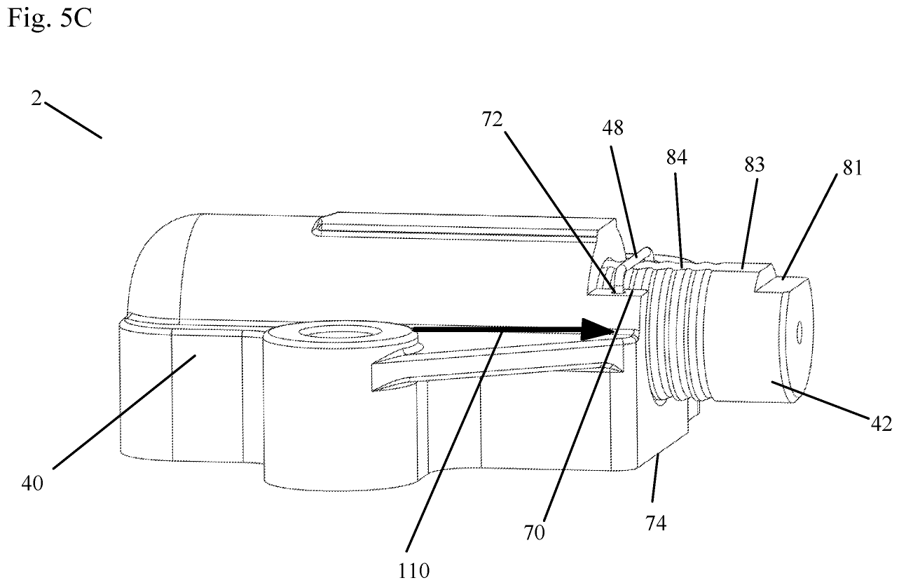

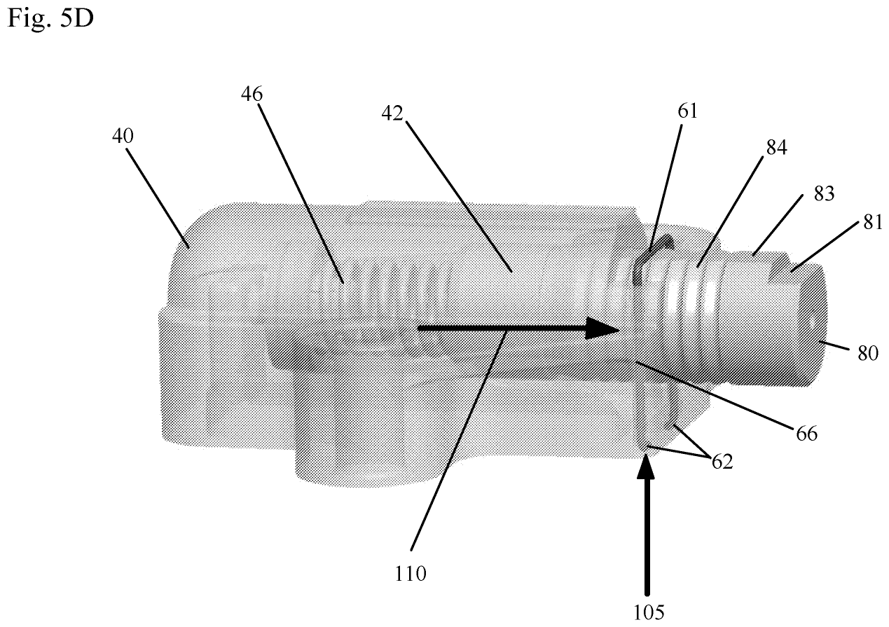

During shipping, it is important to retain the piston 42. As shown in FIGS. 5A and 5B, the connecting section 61 of the ratchet clip 48 contacts the piston step 81 and the ratchet clip legs 66 are located in the two holes 72 of the tensioner body 40. The holes 72 extend through the tensioner body 40 in a width or radial direction 75. The ratchet clip 48 retains the piston 42 without the use of a retaining pin. The bent portion 62 of the ratchet clip legs 66 protrudes from the tensioner bottom surface 76. While the piston 42 is unable to move in this position, the direction in which the piston would move is shown by arrow 110 in FIGS. 5A and 5B.

Spring 46 in the tensioner body bore 41 moves the piston 42 outwards from the tensioner bore 41 after the tensioner is assembled, as shown in FIGS. 5C and 5D. When the user assembles the tensioner 2 on an engine block, the ratchet clip leg end 64 contacts the engine block surface (not shown). The ratchet clip 48 is moved upward (away from the engine block surface) so that the connecting section 61 can clear the height of the second step 83, as shown by the arrow 105, and the piston 42 moves forward (away from the inlet 47 and outwards from the tensioner bore 41), as shown by arrow 110. Since the ratchet clip 48 has been moved up, the bending portions 62 are located in the slot 78 (see FIG. 9B) at the bottom 74 of the tensioner body 40, and are no longer visible in FIG. 5C.

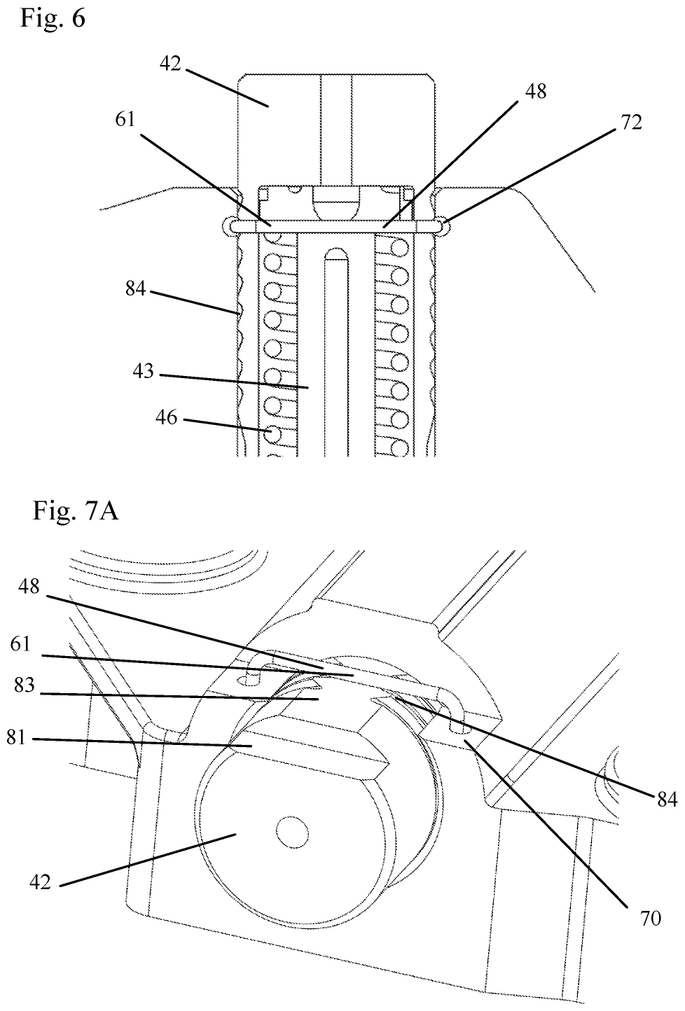

The anti-return function is shown in FIG. 6. The ratchet clip 48 acts as a non-return mechanism coupled to the piston so that the piston extends but does not retract more than a set backlash amount. The ratchet clip 48, located in the two holes 72 on the tensioner body 40, contacts the piston 42 outer surface and the piston teeth 84. This contact and the ratchet mechanism formed between the ratchet clip 48 and the piston teeth 84 create an anti-return function. Since, unlike prior art tensioners, the tensioner body 40 does not have a dedicated opening or ratchet window for placement of the ratchet clip 48, high oil leakage is prevented.

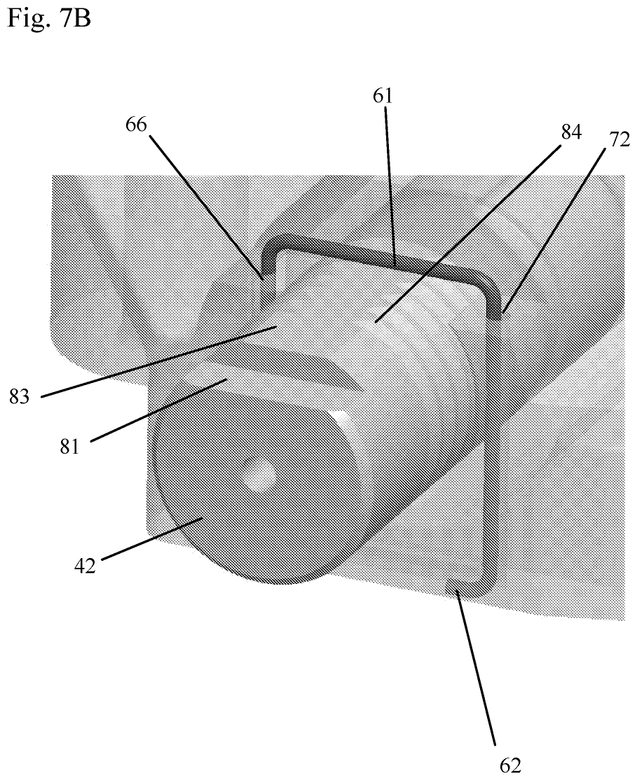

Certain applications may include an anti-rotation function as part of the tensioner. FIGS. 7A and 7B show the interaction between the tensioner body 40, piston 42 and ratchet clip 48 to prevent unwanted rotation. In these embodiments, a piston 42 with two steps 81, 83 works without rotation. The shape and position of the ratchet clip 48 prevents tilting and rotation.

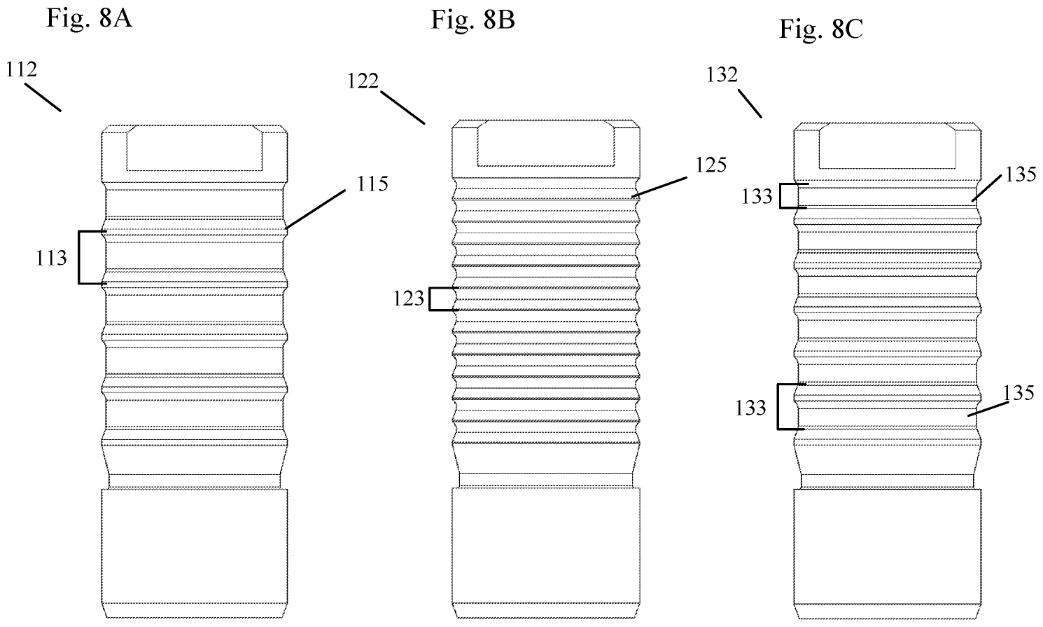

Tensioner backlash is adjustable using variations in piston tooth geometry, as shown in FIGS. 8A-8C. The design of the piston teeth and placement of the piston teeth controls backlash for each application. FIG. 8A shows a piston 112 with tooth geometry 115 that permits a large backlash 113. FIG. 8B shows a piston 122 with tooth geometry 125 with a smaller backlash 123 because the teeth are closer to each other on the piston than the piston teeth in the piston of FIG. 8A. FIG. 8C shows a piston 132 with tooth geometry 135 with double backlash 133. The teeth on the piston 132 have a pattern with two different sizes, to permit two different amounts of backlash. With this design for the piston 132, it is possible to have different backlash depending upon chain system conditions and/or characteristics of a particular application.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A hydraulic tensioner, comprising:
a tensioner body having a bore in fluid communication with a source of pressurized fluid through an inlet;
a hollow piston slidably received within the bore, with an outer diameter comprising a plurality of teeth, an extension end of the piston having at least one first flat top surface;
a hydraulic pressure chamber defined by the hollow piston and the bore of the tensioner body;
a piston spring received within the hydraulic pressure chamber for biasing the piston away from the inlet; and
a substantially U-shaped ratchet clip inserted in a first hole and a second hole in the tensioner body such that the ratchet clip at least partially surrounds an outer diameter of the piston.

2. The tensioner of claim 1, wherein the first hole and the second hole extend through the tensioner body in a radial direction, an open bore of the first hole being positioned adjacent to a first side of the first flat top surface of the piston and an open bore of the second hole being positioned adjacent a second side of the first flat top surface of the piston when the piston is retracted.

3. The tensioner of claim 1, wherein the tensioner body further comprises a second flat top surface that receives the first hole and a third flat top surface that receives the second hole.

4. The tensioner of claim 1, wherein the piston further comprises a second flat top surface adjacent to the first flat top surface.

5. The tensioner of claim 4, wherein the ratchet clip comprises two legs parallel to each other that are inserted into the first hole and the second hole in the tensioner body, a connecting section perpendicular to the two legs connecting the two legs and extending across at least one of the flat top surfaces of the piston, and a bendable section at an end of each leg opposite the connecting section, wherein the bendable sections are bent inwards after assembly of the tensioner.

6. The tensioner of claim 1, wherein the ratchet clip acts as a non-return mechanism coupled to the piston, wherein the non-return mechanism comprises the teeth formed along a length of the piston contacting the legs of the ratchet clip, such that the piston extends, but does not retract more than a set backlash amount.

7. The tensioner of claim 1, wherein the piston teeth are shaped for double backlash.

8. The tensioner of claim 1, wherein the U-shape and location of the ratchet clip in the tensioner prevents rotation of the piston.

9. The tensioner of claim 1, wherein the tensioner does not include a separate retaining pin.

10. A method of controlling piston movement in a tensioner comprising a tensioner body having a bore in fluid communication with a source of pressurized fluid through an inlet, a hollow piston slidably received within the bore, with an outer diameter comprising a plurality of ratchet teeth, an extension end of the piston having at least one first flat top surface, a hydraulic pressure chamber defined by the hollow piston and the bore of the tensioner body, a piston spring received within the hydraulic pressure chamber for biasing the piston away from the inlet, and a ratchet clip comprising two legs parallel to each other, a connecting section perpendicular to the legs that connects the two legs, and a bendable section at an end of each leg opposite the connecting section, comprising the step of:
preventing retraction of the piston more than a set backlash amount, wherein the ratchet clip acts as a non-return mechanism coupled to the piston, wherein the non-return mechanism comprises the plurality of ratchet teeth formed along a length of the piston contacting the legs of the ratchet clip, such that the piston extends, but does not retract more than the set backlash amount.

11. The method of claim 10, further comprising the steps of:
inserting the legs of the ratchet clip into a first hole and a second hole of the tensioner body, wherein the first hole and the second hole extend through the tensioner body in a radial direction; and
bending the ends of the ratchet clip inwards towards each other.

12. The method of claim 10, further comprising the step of preventing rotation of the piston.

13. The method of claim 10, further comprising the step of retaining the piston, wherein the piston further comprises a second flat top surface adjacent the first flat top surface, wherein the second flat top surface has a first height taller than a second height of the first flat top surface, and the connecting section of the ratchet clip is positioned at a third height between the second height of the first flat top surface of the piston and the first height of the second flat top surface of the piston.

14. The method of claim 13, further comprising the step of raising a height of the ratchet clip, wherein, when the ratchet clip makes contact with an engine block surface, the ratchet clip is raised above the first flat top surface a distance sufficient such that the ratchet clip clears the first height of the second flat top surface of the piston.

15. The method of claim 14, further comprising the step of extending the piston.

16. A ratchet clip for a tensioner comprising a tensioner body having a bore in fluid communication with a source of pressurized fluid through an inlet, a hollow piston slidably received within the bore, with an outer diameter comprising a plurality of teeth, an extension end of the piston having at least one first flat top surface, a hydraulic pressure chamber defined by the hollow piston and the bore of the tensioner body, a piston spring received within the hydraulic pressure chamber for biasing the piston away from the inlet, the ratchet clip comprising two legs parallel to each other, a connecting section perpendicular to the legs that connects the two legs, and a bendable section at an end of each leg opposite the connecting section.

17. The ratchet clip of claim 16, wherein the ratchet clip is substantially U-shaped.

18. The ratchet clip of claim 16, wherein the legs of the ratchet clip are inserted in a first hole and a second hole in the tensioner body, wherein the first hole and the second hole extend through the tensioner body in a radial direction, and an entrance to the first hole is positioned adjacent to a first side of the first flat top surface of the piston and an entrance to the second hole is positioned adjacent a second side of the first flat top surface of the piston when the piston is retracted.
